(19) United States
(12) Patent Application Publication
(10) Pub. No.: US 2025/0319997 A1
(43) Pub. Date: Oct. 16, 2025

(54) Lunar Regolith Sintering: Orbital Directed Energy for Lunar Site Preparation

(71) Applicants: Anthony Robert Lackey, Webster, TX (US); Adam Sullivan Wong, Laguna Hill, CA (US)

(72) Inventors: Anthony Robert Lackey, Webster, TX (US); Adam Sullivan Wong, Laguna Hill, CA (US)

(21) Appl. No.: 18/634,356

(22) Filed: Apr. 12, 2024

(51) Int. Cl. B64G 99/00; B22F 3/105; F24S 20/30; F24S 50/40

(52) U.S. Cl. CPC B64G 99/00; B22F 3/105; F24S 20/30; F24S 50/40

(57) ABSTRACT

Described herein is a method of sintering lunar regolith using a lunar-orbital solar concentration device. Among other benefits, this method can reduce the mechanical hazards of lunar regolith by altering it's physical properties, without having mechanical equipment coming into contact with the regolith in the first place. Equipped with a solar concentrator array, a spacecraft orbiting the moon can take flyby shots at a specific area to be sintered every orbital period, heating the area of interest to a sufficient degree that the desired physical change takes place. After a number of orbits, the spacecraft will have created an area of improved lunar surface with regolith burned into larger, less abrasive particles, less damaging to future mechanical missions to be taken on.

### CROSS-REFERENCE TO RELATED APPLICATIONS

This application is a nonprovisional patent application.

### FIELD

The disclosure relates generally to a solar concentrator for the heating of particles using solar energy, non-surface based self-oriented photon concentrator to provide precise and controlled sintering and/or fusion of lunar particles.

### BACKGROUND

Several methods for sintering have been explored and include direct application of concentrated solar energy (CSE) and microwave sintering. Solar energy is an effective, abundantly available energy source in space and on the Earth, but the conventional surface-bound technologies of concentrating solar energy do not provide massed energy in the volumes required at a realistic price for lunar application in soil preparation or dust mitigation opportunities.

Selective sintering of lunar regolith has been a topic of interest to NASA for over a decade due to the benefits in-situ resource utilization (ISRU) may have on space exploration costs and future potential.

The following disclosed technology addresses these needs and improves upon state-of-the-art solar concentration and sintering capabilities by isolating the CSE delivery system (fiber optic or other, for example) from the high temperatures produced on the working surface using an orbital platform that uses a high vantage point to provide the line of sight to affect many different locations on the lunar surface, without causing mechanical failure via contact with lunar regolith, or high repeated asset costs through many different individual sintering devices. The disclosed solar energy particle receiver system acts as a standalone system for preparing lunar sites for future habitation, scientific activity, and other actions by mitigating the worst of the effects of lunar dust, and potentially aiding other mass infrastructure projects required for long term human residency on the moon.

### SUMMARY

The disclosed remote sintering solar energy concentration system consists of a large reflective solar concentrator for heating a target location on the lunar surface to high temperatures using solar energy. The system includes integrated flight components to finely control the CSE spot beam location on the lunar surface. In one embodiment, the particle receiver system may serve as a robot end effector to accept concentrated sunlight from a primary solar concentrator and transmit the concentrated sunlight with even greater concentration onto the lunar surface to selectively sinter and/or melt the lunar soil for additive manufacturing and additive construction on the Moon. Previous concepts for solar concentrators or end-effectors for high temperature directed energy sintering utilized devices that were on the surface, putting that machinery in direct contact with the lunar regolith dust they were attempting to mitigate. This contact with regolith rapidly interferes with normal operations of internal mechanisms, dramatically shortening the operational lifespan of a robotic operation and inflating the cost and risk of a robotic lead operation. These risks are mitigated with the disclosed CSE system, as its positioning off-moon precludes its contact with the lunar surface. While the disclosed system was developed for lunar sintering, the disclosure has broader ramifications for extraterrestrial use cases of ultralarge engineering programs for efficiently heating celestial surfaces or other space objects to very high temperatures using CSE.

As developed for solar additive manufacturing and construction, the remote sintering solar energy concentration system may be incorporated into several future NASA missions to near earth asteroids, the lunar surface, Martian moons, Mars orbit, and the Martian surface. The particle receiver system technology is most useful anywhere that electrical infrastructure is not present and sufficient sunlight is available.

The remote sintering solar energy concentration system addresses the need for a sintering effector and improves upon state-of-the-art solar concentrator and sintering capabilities by, among other things, isolating the solar delivery system (fiber optic or other, for example) from the proximity hazards of the damaging lunar regolith dust working material and high temperatures produced on the working surface. Direct application of CSE also avoids the power loss accrued from energy conversion suffered by the state-of-the-art microwave or laser sintering, allowing greater amounts of energy to be transferred at lower mechanical complexity. The broader swath of more evenly distributed solar power is particularly attuned to the use case of lunar regolith dust mitigation, as the dust is endemic to the lunar surface, and mitigating the hazards of the dust requires lower wattage than fabricating construction materials. The reflective (supplemental) concentrator can receive pre-concentrated solar energy, allowing the directed energy to stack for faster, more complete, or widespread lunar sintering applications.

In one embodiment, the remote sintering solar energy concentration system provides up to or approximately one hundred (100) times wider area sintered, 100 times faster, and at 1/10th the cost. For construction and surface conditioning applications like paving and dust mitigation, the remote sintering solar energy concentration system evenly distributes the solar energy across a wide area, enabling more consistent, efficient, and effective processes.

In one embodiment, a particle receiver system is disclosed, the system comprising: a concentrator configured to receive raw solar energy or secondary concentrator light pattern and output a concentrated beam, a communications module to coordinate optic geometries for beam construction; a flight control system including a flight computer and an attitude and propulsion system, allowing the spacecraft to calculate the appropriate relationship between the orbit, rotation of the Moon, and raster pattern for sintering the scheduled area, and implementing that into attitude adjustments. In one embodiment, the reflective surface is aggregated independently articulately mirrors, or inflatable mirror, or inflatable lens, or inflatable Fresnel lens. In one embodiment, the reflective surface is 80 m in diameter, or 800 m in diameter, depending on the orbit selected, and the commensurate tradeoff in size and maneuverability/agility of the spacecraft. The output pattern would be separated into sintering passes, rasterization of the site with many dozens of passes until each part of the site is prepared to the sufficient degree.

A variant of this system can be placed in Low Lunar Orbit, with an altitude of 60 km and an orbital period of 20 minutes. A variant of this system can be mounted on future planned lunar orbital stations. A variant of this system can be positioned in the Earth Moon Lagrange points L1, L2, L3, and/or L4, for more consistent exposure time for lines of sight to areas of interest, more stable orbital flight paths requiring less propulsion maintenance, more or less interference with planned lunar surface activities, albeit at longer ranges, increasing optical path loss, thereby increasing the required exposure times for reaching high temperatures for sintering or glassification. This alleviates the steering precision requirements, though increases the ultimate mass of the system to compensate for the path loss (1,000× the distance from the surface, but with 1000× the increase in exposure time).

The material acceptable for sintering is lunar regolith specifically, or more generally, a sinterable regolith on any space body which one desires to consolidate or otherwise alter by application of directed CSE. CSE, compared to state of the art laser or microwave sintering, affects a broader swath of lunar surface with more evenly distributed solar power that is particularly attuned to the use case of lunar regolith dust mitigation, as the dust is endemic to the lunar surface, and mitigating the hazards of the dust requires lower wattage than fabricating construction materials. Lunar regolith sintering has been studied as a potential means for creating construction materials, and identified 1200 degrees C. as a melting point for regolith, creating “glassification” of the surface.

In another aspect, the reacted material enables at least one of thermal energy storage and electricity generation. In another aspect, the system further comprises a gas collector configured to aid in lunar industrial programs that require heating large entities in between 250-1500 C. In another aspect, the controller further operates to control the speed of delivery of the working material.

The term “regolith” means any blanket of unconsolidated, loose, heterogeneous superficial deposits that covers solid rock, and may include soil, dust, broken rocks, and other related materials. Regolith is present at least on Earth, the Moon, Mars, and some asteroids.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The disclosure will be readily understood by the following detailed description in conjunction with the accompanying drawings, wherein like reference numerals designate like elements. The elements of the drawings are not necessarily to scale relative to each other. Identical reference numerals have been used, where possible, to designate identical features that are common to the figures.

FIG. 1 is a schematic representation of one embodiment of a remote sintering solar energy concentration system of a Low Lunar Orbit space perspective view of the remote sintering solar energy concentration system situated in the orbits around the moon;

FIG. 2 is a schematic Lagrange point space perspective representation of another embodiment of a remote sintering solar energy concentration system of view of the remote sintering solar energy concentration system situated in the orbits around the moon, the embodiment engaged with a direct primary concentrator;

FIG. 3 is a side elevation view of a remote sintering solar energy concentration satellite;

FIG. 4 is a solar energy diagram illustrating the energy transfer from the sun, in some variations from other concentrator spacecraft, and down into the surface of the moon and effects on lunar regolith.

### DETAILED DESCRIPTION

Reference will now be made in detail to representative embodiments. The following descriptions are not intended to limit the embodiments to one preferred embodiment. It is intended to cover alternatives, modifications, and equivalents as can be included within the spirit and scope of the described embodiments as defined, for example, by the appended claims.

Most broadly, the disclosure describes a remote sintering solar energy concentration system which employs an orbital reflective concentrator with associated controls for high-temperature thermochemical processes on celestial surfaces using CSE. Additional hardware and control methods enable a variety of high temperature processes including thermal energy storage, electricity generation, solar selective melting, selective sintering, calcination of limestone, welding, directed energy deposition, etc.

The disclosed remote sintering solar energy concentration system provides a number of benefits over conventional systems. For example, the system increases addressable lunar surface area for human directed sintering for lunar site preparation, scales to address wider swaths faster or create higher temperatures, and provides a baseline of directed energy transference for extended human activity on the Moon. Its positioning in orbit as opposed to the state of the art on the surface isolates the mechanism from the most damaging and least scalable aspects of lunar site preparation; dust damage, thermal shock, optical component melting, and low asset utilization. Lastly, the system enables use of less precise primary concentrating optics while delivering a consistent concentrated spot profile to a heated target.

The remote sintering solar energy concentration system may achieve, among other things: material's required processing temperature (e.g., 1,100° C.+/−50° C. for sintering lunar regolith), continuous use at required processing temperatures.

The remote sintering solar energy concentration system has been developed to interface with multiple concentrated solar sources including, for example, identical orbital solar energy concentrators to add solar flux surface area and multiply the directed energy to the ultimate area of interest. Benefits of the disclosed remote sintering solar energy concentration system include high transmission efficiency across the spectrum of sunlight by a reflective surface, a more even distribution of output solar flux compared to a single concentrator system, and a scalable system that is, relative to the application, lightweight and easily deployed for large-scale construction applications.

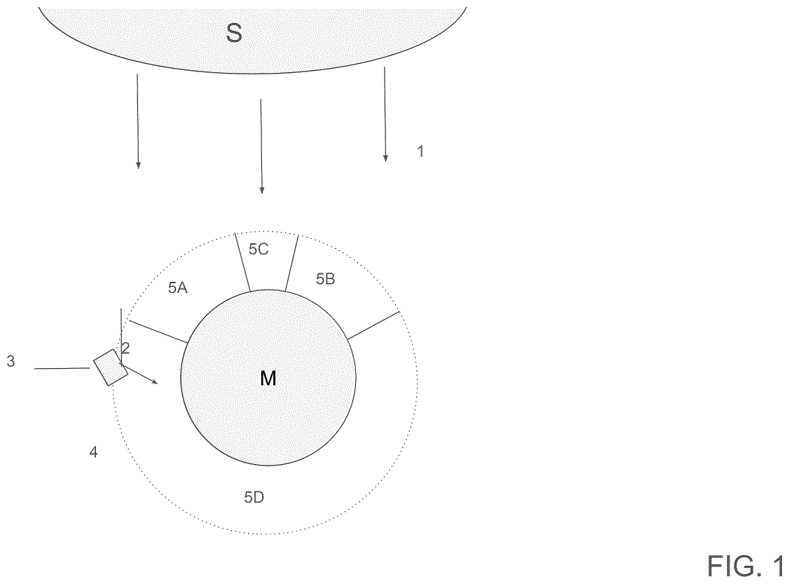

The disclosed devices, systems, and methods of use will be described with reference to FIGS. 1-4. Generally, systems and methods to provide a remote sintering solar energy concentration system and method of use are provided. In one embodiment, a remote sintering solar energy concentration system directs sunlight from a primary concentrator into a supplemental concentrating reflective optics where the emitted sunlight is used to heat or sinter materials such as regolith particles at a controlled temperature. Referring first to FIG. 1, the Sun S-Moon M system are shown from a top down view illustrating the spatial relationship between the bodies and the relationship between the sun's emitted energy 1 and the angle of reflection 2 a spacecraft 3 with a reflecting surface in low lunar orbit 4 may provide to direct meaningful amounts of energy to the lunar surface. The sun S emits 1360.8 w/m2 of solar energy in the vicinity of the Moon M system. The portion of a low lunar orbit 4 where the spacecraft 3 may reflect solar energy 1 onto the lunar surface at a meaningful angle 5A, is equivalent on the other side of the exclusion zone 5B. 5C is the exclusion zone of usable reflection, as the angle of reflection is too acute, meaning the reflective surface of the spacecraft 3 will be minimal working surface area to direct more solar energy 1 than is already hitting the lunar surface. Once the spacecraft 1 transits this exclusion zone 5C, it may flip around and use the rest of the orbital period of productive solar reflection 5B to add more reflective power onto the already, naturally emitted 1360.8 w/m2 from the sun. 5D represents the portion of the lunar orbit 4 that allows an angle of productive solar reflection, which has a favorable angle of reflection for the spacecraft 3 redirecting solar energy 1, but must overcome the lack of natural solar energy already warming the surface up, requiring higher amounts of directed energy 2 to have an equivalent sintering effect.

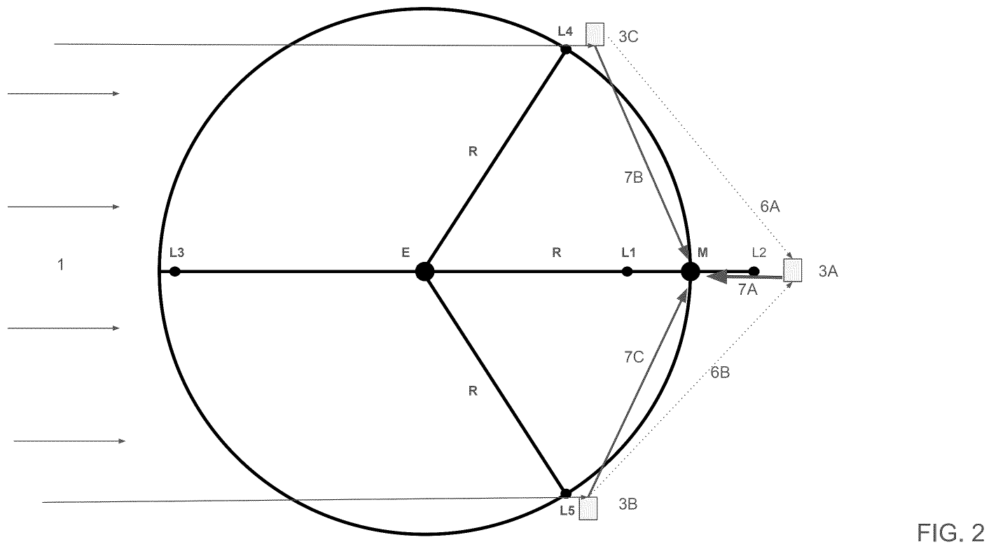

Referring to FIG. 2, the Earth E-Moon M orbital Lagrange points are shown from a top down view, where in one embodiment of the invention, the spacecraft reflectors 3A 3B 3C will reside in these orbital positions. Lagrange points (L1, L2, L3, L4, and L5) are positionally relative points to the Earth E and Moon M where minimal station keeping is required to maintain a spacecraft's position in the areas surrounding those points. R represents the radius of the circle with the vertex as Earth E and circumference defined by the orbit of the moon M, and the value of R is approximately 384 400 km. A spacecraft 3A resides in the L2 orbit L2 and reflects purely on the dark side of the Moon M, which has a favorable angle of reflection for the spacecraft 3A redirecting solar energy, but must overcome the lack of natural solar energy 1 already warming the surface up, requiring higher amounts of directed energy 6 to have an equivalent sintering effect. Spacecraft 3B will be at a further distance from the Lunar surface in an L2 spot compared to some embodiments that orbit at a lower lunar altitude, requiring greater amounts of reflected energy 6B to compensate for the distance loss, and a commensurate increase in the size of the spacecraft. In some embodiments, additional spacecraft in L4 and L5 can also redirect solar energy to the lunar surface, or, in some embodiments, redirect additional solar energy 7B 7C to the spacecraft 3A in L2 to further add to the directed energy 7A it redirects to the lunar surface. The relative direction of solar energy 1 is not fixed to the Earth E-Moon M Lagrange points system, so there will be exclusion zones in this embodiment where the spacecraft 3A 3B 3C will be prevented from reflecting meaningful solar energy 1 to the lunar surface, requiring flight controls and computations onboard the spacecraft.

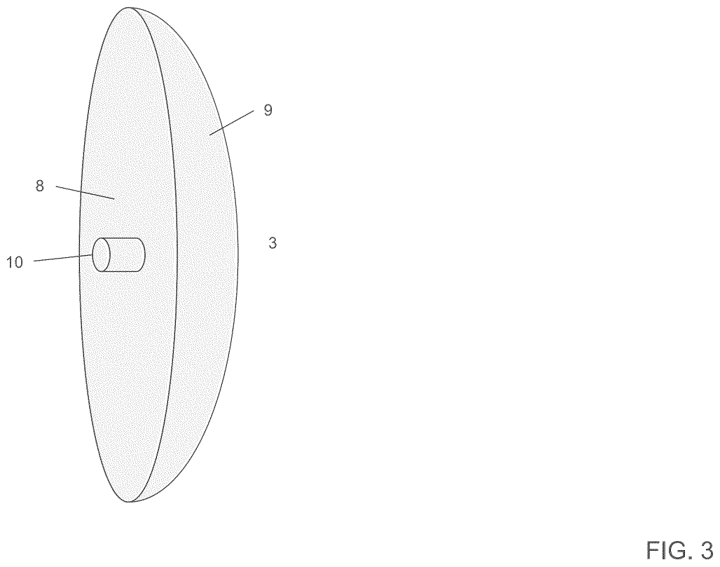

Referring to FIG. 3, the spacecraft 3 is detailed and described across its embodiments. The dominant characteristics of the spacecraft is its large reflecting surface 8, the structure to support that surface 9, and the necessary subsystems 10 to enable its control and proper operation. Regarding the reflective surface 8, there may be an embodiment where the reflective surface ranges in the 1000 m² range, and one that is in the 10 km² range, for low lunar orbit and lagrange point altitudes, respectively. In one embodiment, the reflective surface 8 is a single curved inflatable reflective sheet. In one embodiment, the reflective surface 8 is a stretched reflective sheet with a minimal deformation in the center to produce a lens. In one embodiment, the reflective surface 8 is an array of rigid mirrors that are independently steerable. The spacecraft subsystems 10 will include communications, attitude control, propulsion, flight computer, and an infrared sensor to measure the temperature of the lunar surface at any given moment. There will be a feedback control loop between the IR sensor and the attitude control to control the angle of reflection relative to the (optical) normal. In some embodiments, the flight control systems 10 may be mounted together, or distributed across other structures of the spacecraft.

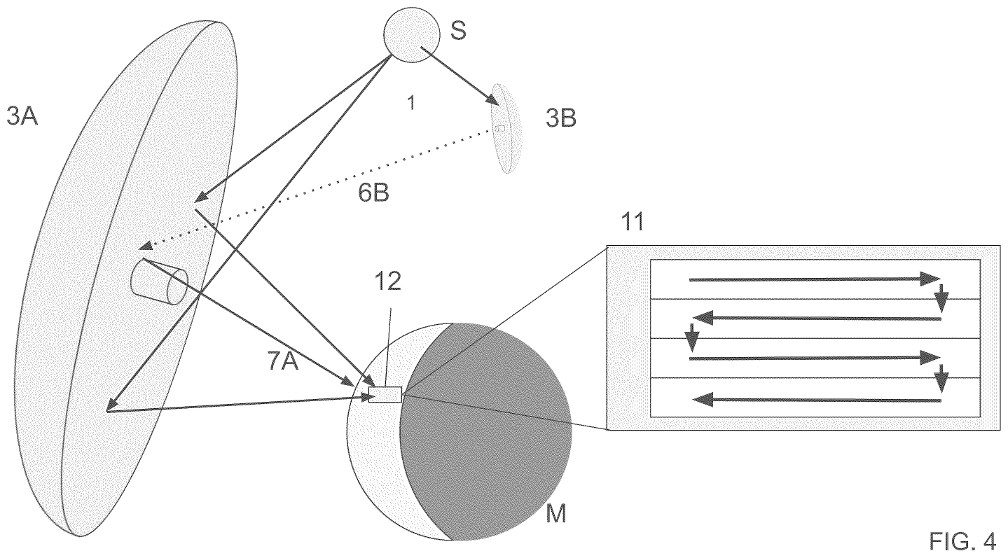

Referring to FIG. 4, the Sun S, Moon M, and multiple spacecraft 3A 3B are illustrated with a diagram describing the directed energy pattern 11 to prepare a lunar site 12. This illustrates how energy 1 from the sun S, and supplemental directed energy 6B from auxiliary reflectors 3B can increase the directed power from the spacecraft 3A without increasing its size as a spacecraft. Spacecraft 3A identifies the lunar site 12 to be prepared, and orients itself to aim the received directed energy 6B to that area. In some embodiments, the spacecraft 3A may focus its lens into a spot size of 60 meters. In some embodiments, the spot size may be focused to an area of 1 km. Once the site 12 is identified, the spacecraft 6A can flex, or otherwise mechanically steer, its reflective surface to the area 12, and move over the area in a raster pattern 11 to beam over each part of the area with the beam's spot size. Several passes may be necessary before the whole area 12 reaches the sufficient temperature of 1600 degrees C. required for sintering to take place, and therefore, for the site to be prepared.

Although the disclosed devices, systems, and methods of use will be principally described relative to a remote sintering solar energy concentration system to irradiate particles (to include, for example, lunar regolith) for use in additive manufacturing, the devices, systems, and methods of use have other applications. For example, the method and/or devices may be used to facilitate and/or enable thermal energy storage, electricity generation, and high temperature thermochemical processes to irradiate particles such as lunar regolith to produce molten reacted material and/or oxygen. Other applications or uses are possible.

I claim:

1. A remote sintering solar energy concentration system comprising:
1. an orbiting solar power reflector,
2. said orbiting solar power reflector having an onboard computer, propulsion, attitude controls, communications, and infrared sensor;
3. said orbiting solar power reflector having a large reflective surface by which to reflect directed energy to a specific and broad swath of celestial and lunar surface;
4. said communications system able to receive commands for areas on the lunar surface to prepare with remote sintering;
5. said infrared sensor in a control loop with the reflective surface to ensure accurate and sufficient solar power emission to create the intended effects on sintering the lunar surface.

2. Energy concentration system of claim 1, wherein the primary spacecraft is supported by auxiliary solar reflecting spacecraft directing power to the primary spacecraft to increase the ultimate spacecraft's emitted power to bring desired improvements on sintering effects on the receiving surface.
